(19) United States
(12) Patent Application Publication
(10) Pub. No.: US 2019/0373821 A1
(43) Pub. Date: Dec. 12, 2019

(54) Removably Securable Potted Plant Jacket

(71) Applicant: Nicklaes Melanson, Anderson, SC (US)

(72) Inventor: Nicklaes Melanson, Anderson, SC (US)

(21) Appl. No.: 16/379,891

(22) Filed: Apr. 10, 2019

Related U.S. Application Data
(60) Provisional application No. 62/681,419, filed on Jun. 6, 2018.

(51) Int. Cl. A01G 13/02

(52) U.S. Cl. CPC A01G 13/0225

(57) ABSTRACT

A removably securable potted plant jacket is provided. The removably securable potted plant jacket includes a housing enclosure having an open upper end and an open lower end, wherein the housing enclosure consists of two members hingedly attached to one another. The open lower end includes a perimeter lip that allows the device to be secured around the upper end of planters and pots of various types and sizes. The housing enclosure includes a closure flap which runs along the length of the housing enclosure from the open top end to the open bottom end along the point of contact of the two housing members. The closure flap is removably securable using a fastener such as a hook and loop assembly. The device is adapted to protect plants from high winds and other environmental hazards, while the open upper end allows mist to moisten the plant protected within.

### CROSS REFERENCE TO RELATED APPLICATIONS

This application claims the benefit of U.S. Provisional Application No. 62/681,419 filed on Jun. 6, 2018. The above identified patent application is herein incorporated by reference in its entirety to provide continuity of disclosure.

### BACKGROUND OF THE INVENTION

The present invention relates to potted plant covers. More specifically, the present invention relates to a removably securable potted plant jacket having an open upper end and an open lower end wherein a closure flap is configured to selectively provide access to a secondary opening.

Many potted plants are frequently stored outdoors on a patio, porch, or other outdoor location. If left uncovered, a potted plant left outdoors can be susceptible to oversaturation from precipitation such as rain, sleet or snow. In addition, winds and flying debris can cause substantial damage to the plant and impede its growth. Individuals may spend excessive amounts of time and money to restore potted plants to a suitable condition or replace them altogether. In situations in which individuals spend money in the hopes of restoring the health of potted plants, they may come to find that the plants are irreparably damaged or unable to grow optimally, if at all, thereby experiencing disappointment and a sense of loss from the time and energy invested. Accordingly, a device that is configured to provide outdoor protection to a potted plant while enabling the watering thereof is desired.

Devices have been disclosed in the known art that relate to potted plant covers. These include devices that have been patented and published in patent application publications. One of these devices relates to a collapsible protective plant cover having a pair of vertically spaced and coaxial support rings of spring steel. Another device relates to an oversized conical sleeve disposed in an encircling relation about the flower pot. The devices in the known art, however, fail to disclose a potted plant cover including an open upper end and a closure flap configured to selectively provide access to a secondary opening for use when watering the protected plant.

In light of the devices disclosed in the known art, it is submitted that the present invention substantially diverges in design elements from the prior art and consequently it is clear that there is a need in the art for an improvement to existing potted plant covers. In this regard, the instant invention substantially fulfills these needs.

### SUMMARY OF THE INVENTION

In view of the foregoing disadvantages inherent in the known types of potted plant covers now present in the known art, the present invention provides a removably securable potted plant jacket wherein the same can be utilized for providing convenience for the user when providing a protecting jacket for outdoor potted plants to be protected from the elements.

It is therefore an object of the present invention to provide a new and improved removably securable potted plant jacket that has all of the advantages of the known art and none of the disadvantages.

It is another object of the present invention to provide removably securable potted plant jacket comprising a housing enclosure having a first member and a second member hingedly attached to one another wherein the housing defines an open top end and an open bottom end when in a closed position, a closure flap which runs the length of the housing enclosure from the open top end to the open bottom end along the portion where the first member and the second member of the housing enclosure meet when in a closed position, a fasten to secure the closure flap, and a perimeter lip which extends out from the open bottom end such that the diameter of the perimeter lip is larger than that of the open bottom end.

Another object of the present invention is to provide a removably securable potted plant jacket wherein the housing enclosure comprises a hard, transparent material to allow light to pass through while also maintaining the structural integrity during severe weather, such as synthetic polymers or plastic.

It is another object of the present invention to provide a removably securable potted plant jacket wherein the perimeter lip is connected to the open bottom end via an elastic material to accommodate planter pots of varying diameters.

Yet another object of the present invention is to provide a removably securable potted plant jacket wherein the housing enclosure comprises a circular cross-section when in a closed position.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of an embodiment of the removably securable potted plant jacket in a closed position.

FIG. 2 shows a front view of an embodiment of the removably securable potted plant jacket in an open position.

FIG. 3 shows a top-down view of an embodiment of the removably securable potted plant jacket in an open position.

FIG. 4 shows a top-down view of an embodiment of the removably securable potted plant jacket in a closed position around a plant.

FIG. 5 shows a front view of an embodiment of the removably securable potted plant jacket with a rectangular cross-section.

### DETAILED DESCRIPTION OF THE INVENTION

Reference is made herein to the attached drawings. Like reference numerals are used throughout the drawings to depict like or similar elements of the removably securable potted plant jacket. For the purposes of presenting a brief and clear description of the present invention, the preferred embodiment will be discussed as used for removably installing a cover over potted plants which are kept outdoors to provide protection from the elements, such as wind and excess rain. The figures are intended for representative purposes only and should not be considered to be limiting in any respect.

Referring now to FIG. 1, there is shown a front view of an embodiment of the removably securable potted plant jacket in a closed position. The removably securable potted plant jacket 11 comprises a housing enclosure 12 adapted to be installed around a plant to give it protection from the elements while also allowing from light and water to still be received by the plant therein. The housing enclosure 12 has a first member 13 which is hingedly connected to a symmetrical second member 14, such that the two housing members 13, 14 are movable between an open position and a closed position. The housing members 13, 14 define an enclosure with an interior volume having an open top end 15 and open bottom end 16 when in the closed position. The closed position is defined when the two symmetrical housing members 13, 14 have their proximal edges along the side having the hinged connection as well as the distal edges laying flush against each other. In the illustrative embodiment, the housing enclosure 12 has a circular cross-section along the vertical axis when in a closed position. A perimeter lip 17 extends orthogonally outward from the perimeter of the open bottom end 16 such that the diameter of the perimeter lip 17 is greater than that of the open bottom end 16.

The perimeter lip 17 includes a flange 18 which extends downward from the perimeter lip 17 while angling inward toward the open bottom end 16.

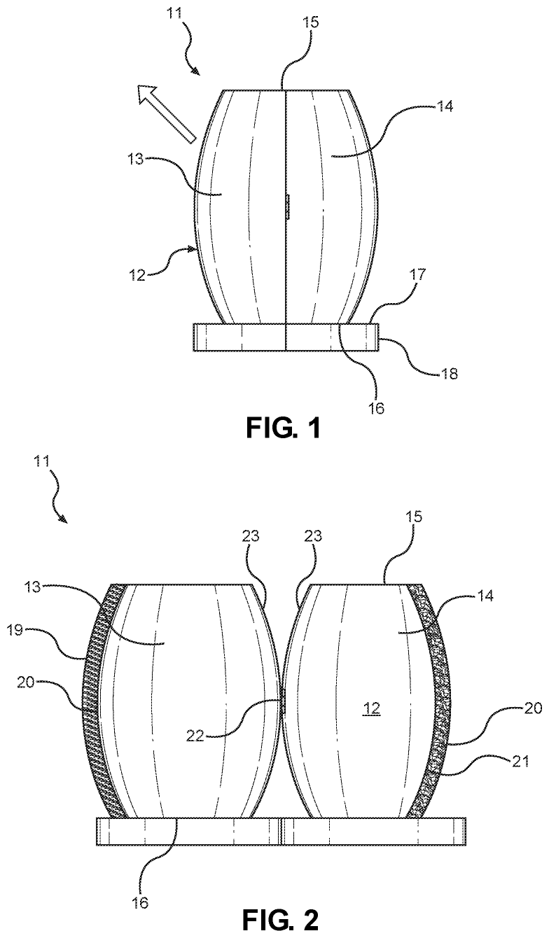

Referring now to FIG. 2, there is shown a front view of an embodiment of the removably securable potted plant jacket in a closed position. In the illustrated embodiment, each housing member 13, 14 has a substantially concave shape such that the two members 13, 14 create a tubular enclosure with an open top 15 and open bottom 16 when in a closed position. The concave shape allows plants to expand laterally as they grow within the enclosure. A closure flap 19 runs along the length of the distal edge 20 of one of the first housing member 13. In the illustrative embodiment, the closure flap 19 may be removably secured via a hook and loop fastener 21 assembly. The housing enclosure 12 defines an open position when the two symmetrical housing members 13, 14 are opened using the hinge 22 connecting the proximal edges 23 of the housing members 13, 14. When in an open position, the proximal and distal edges 23 and 20 of each housing member 13, 14 are separated from one another such that they no longer lay flush and instead pivot along the hinge 22. To transition from a closed to open position, a user must removably detach the fastener 21 of the closure flap 19 in order to separate the two housing members 13, 14 from one another.

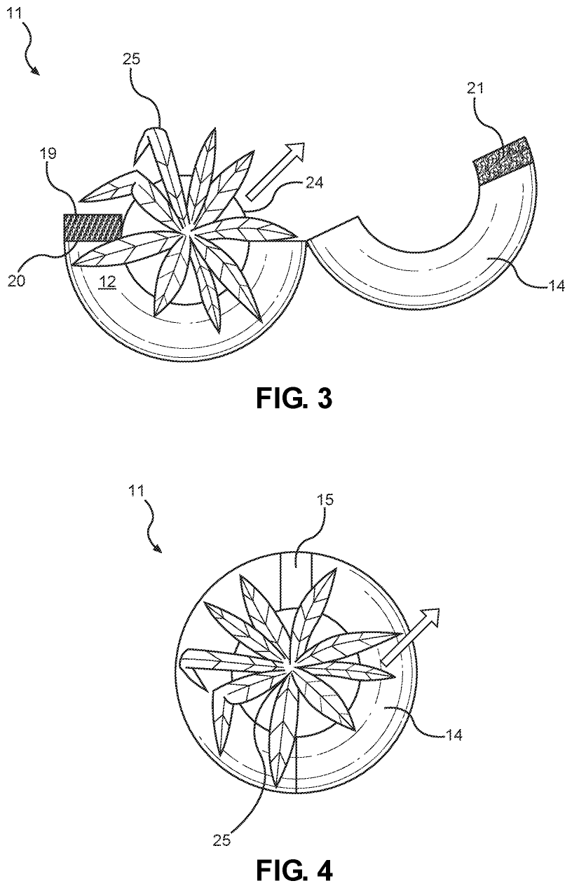

Referring now to FIG. 3 and FIG. 4, there is shown a top-down view of an embodiment of the removably securable potted plant jacket in an open position and a top-down view of an embodiment of the removably securable potted plant jacket in a closed position, respectively. In practice, the removably securable potted plant jacket 11 is secured onto the top of a planter pot 24 for use in protecting a plant 25 kept outside from the elements such as high winds and rain. When in an open position, the removably securable potted plant jacket 11 is moved into position to be removably secured to the top of a planter pot 24. A user may removably secure the device 11 to a top rim of a planter pot 24 by placing the housing enclosure 12 over the planter pot 24 such that the perimeter lip sits atop the rim. A user may then place the device 11 into a closed position and removably secure the housing 12 by attaching the closure flap 19 to the fastener 21 on the distal edge 20 of the second housing member 14. The flange on the perimeter lip will engage the rim of the planter pot 24 to secure via friction fit. The inward angle of flange prevents the removable securable potted plant jacket 11 from being knocked or lifted from the rim of the planter pot 24. The open bottom end allows the plant 25 to access the interior volume of the enclosed housing 12 while the open top end allows a user to selectively water the plant 25 while also limiting the amount of rain water that may reach the soil, thus protecting from overwatering.

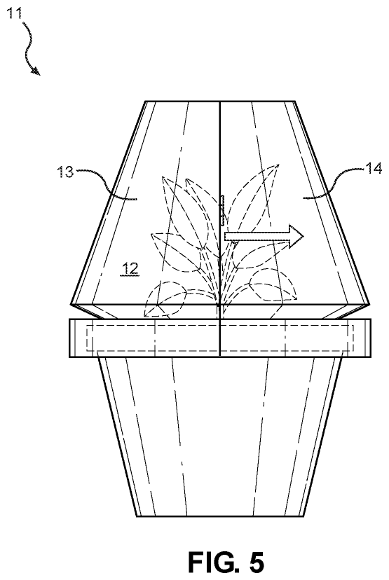

Referring now to FIG. 5, there is shown a front view of an embodiment of the removably securable potted plant jacket with a rectangular cross-section. In the illustrative embodiment, the first and second housing members 13, 14 are composed of a synthetic polymer such as plastic. However, in alternate embodiments of the removably securable potted plant jacket 11, the housing enclosure 12 may be composed of any suitable material which is transparent or substantially transparent and rigid in construction. The transparent nature of the housing allows for the sun to pass through and create a greenhouse effect within the interior volume of the housing 12 while the rigid construction holds its shape during extreme weather and wind. Alternate embodiments may also include housing enclosures 12 having differing cross-sectional shapes. For example, FIG. 5 illustrates a removably securable potted plant jacket 11 having a rectangular cross-section for planter pots having a rectangular outer rim.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A removably securable potted plant jacket, comprising:
a housing enclosure having a first member and a second member hingedly attached to one another, the first member and second member configured to rotated between a closed position and an open position, wherein the housing defines an open top end and an open bottom end when the first and second members are in the closed position;
a closure flap which runs the length of the housing enclosure from the open top end to the open bottom end along the portion where the first member and the second member of the housing enclosure meet when in the closed position;
a fastener configured to removably secure the closure flap; and
a perimeter lip which extends out from the open bottom end such that the diameter of the perimeter lip is larger than that of the open bottom end.

2) The removably securable potted plant jacket of claim 2, wherein the hard, transparent material of the housing enclosure comprises a synthetic polymer.

3) The removably securable potted plant jacket of claim 1, wherein the fastener comprises a hook and loop assembly disposed along a length of the closure flap.

4) The removably securable potted plant jacket of claim 1, wherein the perimeter lip is connected to the open bottom end via an elastic material that is configured to accommodate planter pots of varying diameters.

5) The removably securable potted plant jacket of claim 1, wherein the housing enclosure comprises a circular cross-section when the first member and the second member are in the closed position.

6) The removably securable potted plant jacket of claim 5, wherein a diameter of a central portion of the housing enclosure is greater than each of a diameter of the open top end and a diameter of the open bottom end.

7) The removably securable potted plant jacket of claim 5, wherein the housing enclosure comprises a rectangular cross-section when the first member and the second member are in the closed position.

8) The removably securable potted plant jacket of claim 5, wherein the perimeter lip is configured to receive the top end of a planter pot therein in frictional engagement.
